(19) United States
(12) Patent Application Publication
(10) Pub. No.: US 2011/0059774 A1
(43) Pub. Date: Mar. 10, 2011

(54) Wireless Communication Device for Providing a Visual Representation of a Widget

(75) Inventors: Bruce P. Clift, Scotts Valley, CA (US); Joshua E. Campbell, Chicago, IL (US); Kitae Kim, Chicago, IL (US); James E. Palmer, San Jose, CA (US)

(73) Assignee: MOTOROLA, INC., Schumburg, IL (US)

(21) Appl. No.: 12/556,783

(22) Filed: Sep. 10, 2009

(51) Int. Cl. H04B 1/38

(52) U.S. Cl. 455/566

(57) ABSTRACT

There is disclosed a wireless communication device comprising a display providing a visual representation of a widget. For one embodiment, a wireless transceiver receives a textual content and a tag, a processor determines whether the wireless transceiver has received a graphical content associated with the textual content and the tag. The display provides the textual content in a first window and the graphical content adjacent to the first window in response to determining that the graphical content has been received. The display provides the textual content in a larger, second window in response to determining that the graphical content has not been received. For another embodiment, the wireless transceiver receives a textual content, a graphical content, and a content identifier corresponding to a content header. The display provides a window for each of the textual content, the graphical content, and the content header corresponding to the content identifier, such that the graphical content and content header are positioned at opposites sides of the textual content.

### RELATED APPLICATIONS

This application is related to U.S. application Ser. No. ______, filed Sep. 9, 2009, titled PORTABLE ELECTRONIC DEVICE FOR PROVIDING A VISUAL REPRESENTATION OF A WIDGET (Attorney Docket No. CS37220).

### FIELD OF THE INVENTION

The present invention relates generally to the field of portable electronic devices and, more particularly, to the field of a portable electronic device having a display for providing widgets.

### BACKGROUND OF THE INVENTION

A portable electronic device is capable of interacting with a user and transportable due to its diminutive size and portable power supply. An example of a portable electronic device is a wireless communication device, which provides long-range communication of voice or data over a communication network of specialized base stations to other communication devices remote from the wireless communication device. Portable electronic devices come in a variety of form factors, such as brick, bar, flip/clamshell, slider or rotator/swivel form factors, and each form factor can have a touchscreen or QWERTY keypad. Regardless of the small form factor, the device generally includes a display to convey information to a user or otherwise facilitate the user's use and enjoyment of the device.

Displays of portable electronic devices may provide a variety of visual objects, and one type of visual object is a widget. Widgets are interactive virtual tools that provide single-purpose services, such as providing the user the news, weather, time, calendar, or other single-purpose information. On a portable electronic device, widgets provide a user of the device high level snippets of information at a glance. A widget may include an image or icon to aid the user's comprehension of the information. The challenge is providing an informative widget within a minimal area of the display, due to the diminutive size of the device.

### BRIEF DESCRIPTION OF THE DRAWINGS

FIG. 1 is a perspective view of an embodiment in accordance with the present invention in which the front, left and bottom surfaces of the embodiment are shown.

FIG. 2 is a block diagram of example components of the embodiment of FIG. 1.

FIG. 3 is a screen view providing visual representations of example widgets in accordance with the present invention.

FIG. 4 is a partial screen view providing a visual representation of another example widget in accordance with the present invention.

FIG. 5 is another screen view providing visual representations of other example widgets in accordance with the present invention.

### DETAILED DESCRIPTION OF THE EMBODIMENTS

One aspect of the present invention is a wireless communication device comprising a wireless transceiver, a processor and a display. The wireless transceiver receives a textual content and a tag associated with a particular application at the wireless communication device. The processor determines whether the wireless transceiver has received a graphical content associated with the textual content and the tag. The display provides a visual representation of a widget associated with the tag received by the wireless transceiver. The display provides a first window including the textual content and at least a portion of the graphical content adjacent to the first window in the visual representation in response to determining that the wireless transceiver received the graphical content. The display provides a second window including the textual content in the visual representation in response to determining that the wireless transceiver has not receive the graphical content. The second window is larger than the first window.

Another aspect of the present invention is a wireless communication device comprising a wireless transceiver and a display. The wireless transceiver receives a textual content, a graphical content, and a content identifier. The display provides a visual representation of a widget. The display provides a first window including the textual content, a second window including at least part of the graphical content, and a third window including a content header corresponding to the content identifier. The second and third windows are adjacent to, and positioned at opposing sides of, the first window.

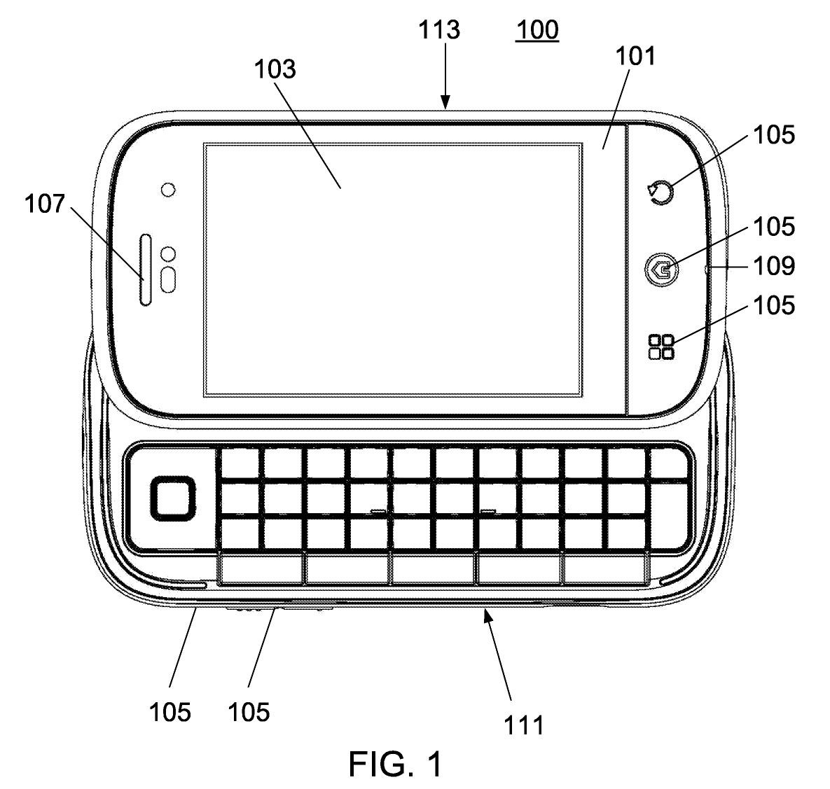

Referring to FIG. 1, there is illustrated a perspective view of an example portable electronic device 100 in accordance with the present invention. The device 100 may be any type of device capable of providing a visual representation of a widget. Examples of the portable electronic device 100 include, but are not limited to, cellular-based mobile phones, WLAN-based mobile phones, personal digital assistants, personal navigation device, touch screen input device, pen-based input devices, portable video and/or audio players, and the like.

For one embodiment, the portable electronic device 100 has a housing comprising a front surface 101 which includes a visible display 103 and a user interface. For example, the user interface may be the touch-sensitive surface that overlays the display 103. For another embodiment, the user interface of the portable electronic device 100 may include a touch-sensitive surface supported by the housing and does not overlay any type of display. For yet another embodiment, the user interface of the portable electronic device 100 may include one or more input keys 105 used in conjunction with the touch-sensitive surface. Examples of the input key or keys 105 include, but are not limited to, keys of an alpha or numeric keypad, a physical keys, touch-sensitive surfaces, mechanical surfaces, multipoint directional keys and side buttons 105, 111. The portable electronic device 100 may also comprise apertures 107, 109 for audio output and input at the surface. It is to be understood that the portable electronic device 100 may include a variety of different combination of displays and interfaces.

It is to be understood that the portable electronic device 100 make take the form of a variety of form factors, such as bar, flip/clam, slider and rotator form factors. For example, for the embodiment shown in FIG. 1, the portable electronic device 100 may include a first housing 111 having an upper surface, a second housing 113 having a lower surface slidably coupled to the upper surface of the first housing. As represented in FIG. 1, the device 100 is shown in a closed position. The second housing 113 is capable of sliding to a closed position relative to the first housing in which upper and lower surfaces are substantially adjacent and concealed. The device 100 may also open to an open position. The second housing 113 is capable of sliding to an open position relative to the first housing 111 in which only a portion of the upper and lower surfaces are adjacent and concealed and the remainders of the upper and lower surfaces are offset and exposed. For another embodiment, the second housing may support a display, a first user interface, an audio input, and an audio output, and the first housing may support a second user interface and a wireless transceiver.

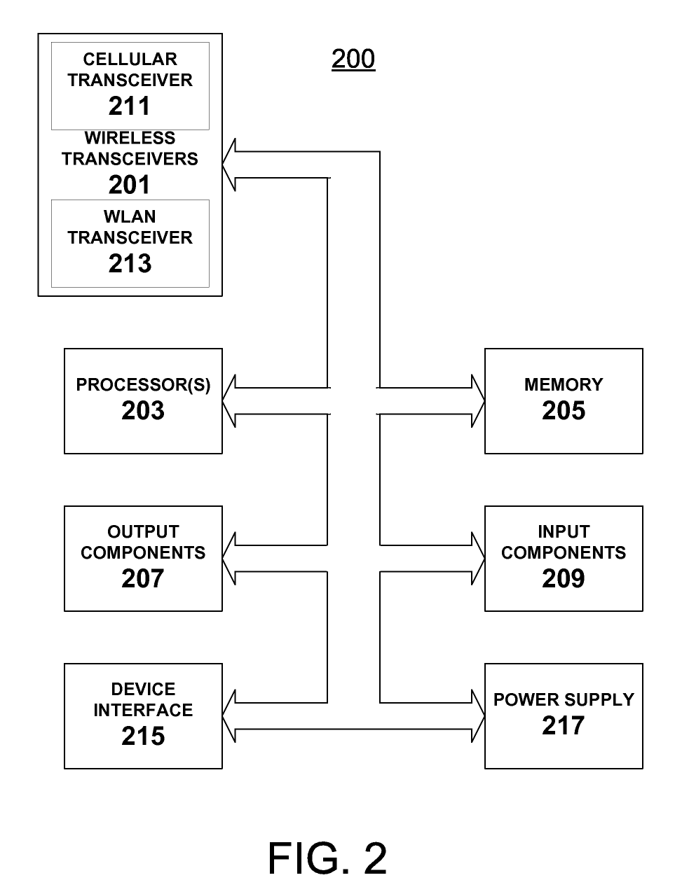

Referring to FIG. 2, there is shown a block diagram representing example components that may be used for an embodiment in accordance with the present invention. The example embodiment may includes one or more wireless transceivers 201, one or more processors 203, one or more memories 205, one or more output components 207, and one or more input components 209. Each embodiment may include a user interface that comprises one or more output components 207 and one or more input components 209. Each wireless transceiver 201 may utilize wireless technology for communication, such as, but are not limited to, cellular-based communications such as analog communications (using AMPS), digital communications (using CDMA, TDMA, GSM, iDEN, GPRS, or EDGE), and next generation communications (using UMTS, WCDMA, LTE, LTE-A or IEEE 802.16) and their variants, as represented by cellular transceiver 311. Each wireless transceiver 201 may also utilize wireless technology for communication, such as, but are not limited to, peer-to-peer or ad hoc communications such as HomeRF, Bluetooth and IEEE 802.11(a, b, g or n); and other forms of wireless communication such as infrared technology, as represented by WLAN transceiver 213. Also, each transceiver 201 may be a receiver, a transmitter or both.

The processor 203 may generate commands based on information received from one or more input components 209. The processor 203 may process the received information alone or in combination with other data, such as the information stored in the memory 205. Thus, the memory 205 of the internal components 200 may be used by the processor 203 to store and retrieve data. The data that may be stored by the memory 205 include, but is not limited to, operating systems, applications, and data. Each operating system includes executable code that controls basic functions of the portable electronic device, such as interaction among the components of the internal components 200, communication with external devices via each transceiver 201 and/or the device interface (see below), and storage and retrieval of applications and data to and from the memory 205. Each application includes executable code utilizes an operating system to provide more specific functionality for the portable electronic device. Also, the processor is capable of executing an application associated with a particular widget shown at an output component 207. Data is non-executable code or information that may be referenced and/or manipulated by an operating system or application for performing functions of the portable electronic device.

The input components 209, such as a user interface, may produce an input signal in response to detecting a predetermined gesture at the touch-sensitive surface. As a result, a transceiver 201 may terminate communication with the remote device in response to the input signal from the user interface. In addition, the input components 209 may include one or more additional components, such as a video input component such as an optical sensor (for example, a camera), an audio input component such as a microphone, and a mechanical input component or activator such as button or key selection sensors, touch pad sensor, another touch-sensitive sensor, capacitive sensor, motion sensor, and switch. Likewise, the output components 207 of the internal components 200 may include one or more video, audio and/or mechanical outputs. For example, the output components 207 may include a video output component such as a cathode ray tube, liquid crystal display, plasma display, incandescent light, fluorescent light, front or rear projection display, and light emitting diode indicator. Of particular interest are displays that are capable of providing a visual representation of a widget. Other examples of output components 207 include an audio output component such as a speaker, alarm and/or buzzer, and/or a mechanical output component such as vibrating or motion-based mechanisms.

The internal components 200 may further include a device interface 215 to provide a direct connection to auxiliary components or accessories for additional or enhanced functionality. In addition, the internal components 200 preferably include a power source 217, such as a portable battery, for providing power to the other internal components and allow portability of the portable electronic device 100.

It is to be understood that FIG. 2 is provided for illustrative purposes only and for illustrating components of a portable electronic device in accordance with the present invention, and is not intended to be a complete schematic diagram of the various components required for a portable electronic device. Therefore, a portable electronic device may include various other components not shown in FIG. 2, or may include a combination of two or more components or a division of a particular component into two or more separate components, and still be within the scope of the present invention.

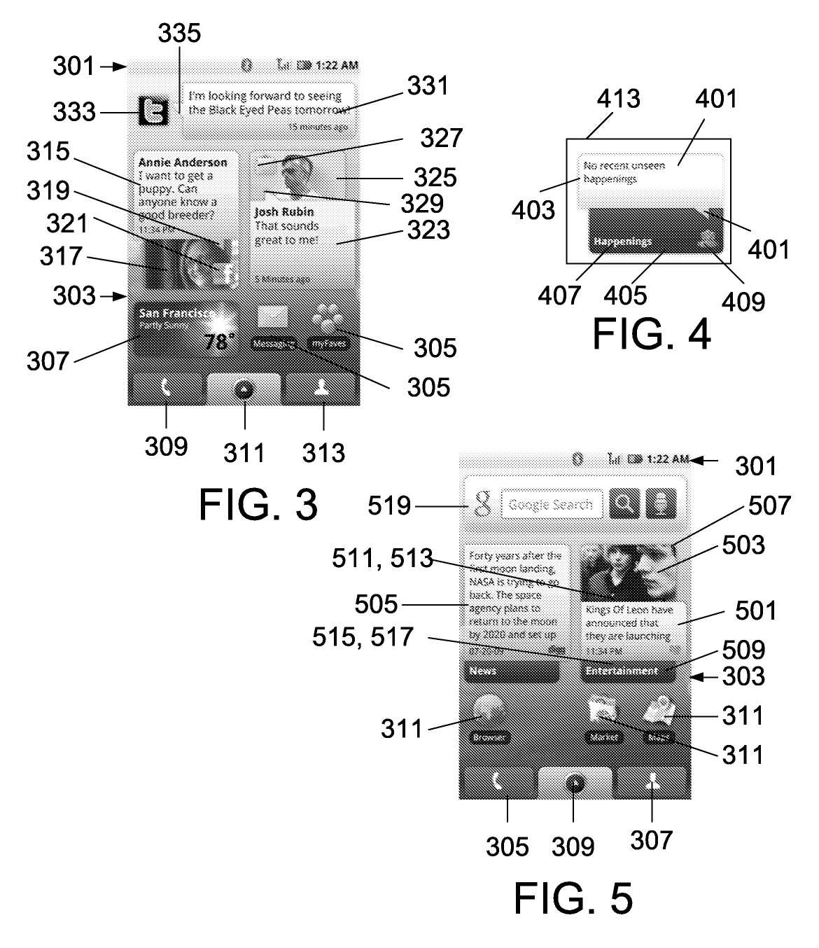

Referring to FIG. 3, there is shown a screen view providing visual representations of example widgets in accordance with the present invention. The screen view represents a front surface of an output component 207, such as a display, providing a visual representation of one or more widgets. For the embodiment shown in FIG. 3, the screen view shows a home screen, or one of multiple home screens, which is a graphical list of available applications represented by icon and/or widgets. The home screen is often a default, idle screen when a portable electronic device is initially powered-on.

The screen view may include various optional elements to facilitate a user's operation of the portable electronic device. For example, as shown in FIG. 3, the screen view may include a status bar 301, which is generally an elongated, linear portion of the screen that indicates the status of various components and/or operations of the portable electronic device. The screen view may also include an open area 303 for displaying the graphical list of available applications. For example, the open area 303 may include icons 305 and/or widgets 307 for activating, in part or in whole, an application stored in a memory of the portable electronic device. The screen view may further include functional buttons 309 for activating particular operations of the portable electronic device, such as one or more calling functions; dedicated buttons 311 for activating specific operations of the portable electronic device that are persistently or semi-persistently shown at the screen view; and pull-down, pull-up, or gesture-activated screens 313 for providing additional screen views that may be utilized for more graphical lists of available applications.

The screen view includes a visual representation of a widget comprising a first window 315 including textual content, such as a message, and a second window 317 including a graphical content, such as a still image or dynamic video. The first and second windows 315, 317 are situated within a periphery of the visual representation such that, where the first and second windows meet, the first window overlaps part of the second window and a portion of the graphical content of the second window is obscured by the first window. For example, as shown in FIG. 3, the top portion of the photograph is not shown, since the bottom portion of the first window 315 is position in front of this obscured area of the photograph. For another embodiment, the first window 315 consists of the textual content without any graphical content, and the second window 317 consists of a single graphical content without any textual content.

The shape of the first and second windows 315, 317 may vary, but generally first window has a substantially polygonal shape and the second window has a substantially polygonal shape. For example, as shown in FIG. 3, the first and second windows 315, 317 are substantially rectangular with one or more curved corners. Likewise, the graphical content of the second window 317 has a substantially polygonal shape corresponding to the substantially polygonal shape of the second window.

The first and second windows 315, 317 may also have characteristics to associate themselves with each other and clearly indicate to the user that they are combined for a single visual representation of a single widget. For example, the first window 315 may include an outer boundary, and an angular protrusion 319 extending from the outer boundary and over the second window 317. For another embodiment, the second window 317 does not consist of a single graphical content, but also includes a graphical icon. Thus, the angular protrusion 319 may be directed toward the graphical icon, which may provide more information about the textual content of the first window 315, such as a source of the textual content. Also, the textual content of the first window 315 provides a description relating to the graphical content of the second window 317.

The screen view may include a plurality of visual representations. Referring to the example visual representations shown side-by-side in FIG. 3, the visual representations may comprise a first window 315, 323 including a peripheral boundary surrounding a textual content and a second window 317, 325 including a graphical content and a graphical icon 321, 327 overlaying a part of the graphical content. A portion of the peripheral border of the first window 315, 323 includes an outwardly protruding section 319, 329, which is angular and includes a point directed towards the graphical icon 321, 327 of the second window 317, 325.

The screen view may further include variations of the above-described visual representations. For example, as shown in FIG. 3, a visual representation may comprise a first window 331 including a peripheral boundary surrounding a textual content and a second window 333 solely including a graphical icon. A portion of the peripheral border of the first window 331 includes an outwardly protruding section 335, which is angular and includes a point directed towards the graphical icon of the second window 333.

Referring to FIG. 4, there is shown a single visual representation of another example widget in accordance with the present invention. The visual representation comprises a first window 401 including a peripheral boundary 403 surrounding a textual content and a second window 405 including a textual heading 407 and a graphical icon 409. For one embodiment, the first window 401 surrounds the textual content without any graphical content, and the second window 405 consists of a single graphical icon 409 and the textual content, i.e., textual heading 407. A portion of the peripheral border of the first window includes an outwardly protruding section 411 directed towards the graphical icon 409 of the second window 405. Also, as with the visual representations above, the first and second windows 401, 405 are situated within a periphery 413 of the visual representation, thus indicating a single visual representation of an individual widget.

Similar to the other windows described above, the shape of the first and second windows 401, 405 may vary, but generally first window has a substantially polygonal shape and the second window has a substantially polygonal shape. For example, as shown in FIG. 4, the first and second windows 401, 405 are substantially rectangular with one or more curved corners.

Referring to FIG. 5, another screen view providing visual representations of other example widgets in accordance with the present invention. For this embodiment, the size and/or dimensions of windows of a visual representation may differ based on the content received by a portable electronic device, particularly a wireless communication device. Even so, the size and/or dimensions of the visual representation itself may be the same in any case for consistency and efficient use of valuable space of the display. For example, the wireless communication device may comprise a wireless transceiver, a processor and a display. The wireless transceiver may receive a textual content and a tag associated with a particular application at the wireless communication device. The processor may determine whether the wireless transceiver has received a graphical content associated with the textual content and the tag. The display may provide a visual representation of a widget associated with the tag received by the wireless transceiver. As stated for other embodiments above, the first and second windows may consist of the textual content without any graphical content, and the graphical content may consist of a single graphical content without any textual content.

As shown in FIG. 5, the screen view of the display may provide a first window 501 including the textual content and at least a portion of the graphical content 503 adjacent to the first window in the visual representation in response to determining that the wireless transceiver received the graphical content. On the other hand, the screen view of the display may provide a different-size and/or different-dimension window, i.e., a second window 505 including the textual content in the visual representation in response to determining that the wireless transceiver has not receive the graphical content. For this example, the second window 505 is larger than the first window 501 because, without the graphical content, the second window 505 has more room within the boundaries of the visual representation to present content.

For one embodiment, as illustrated by FIG. 5, the height of the second window 505 may greater than the height of the first window 501. In particular, the first window 501 may have a first width and a first height, and the second window 505 may have a second width and a second height; in which the first and second widths are substantially the same whereas the second height is greater than the first height. For another embodiment, the width of the second window 505 may be greater than the width of the first window 501. Thus, the first window 501 may have a first width and a first height, and the second window 505 may have a second width and a second height; in which the first and second heights are substantially the same whereas the second width is greater than the first width. For still another embodiment, the width and height of one window may be greater than the width and height of the other window.

It should be noted that the timing for receiving the graphical content relative to the textual content and tag may vary. For one embodiment, the wireless transceiver may receive the graphical content concurrently with the textual content and the tag. For another embodiment, the wireless transceiver may receive the graphical content within a predetermined time period of receiving the textual content and the tag.

The visual representations may further include distinguishing characteristics for the different types of content therein. For example, the textual content and the at least a portion of the graphical content may have differing background colors, i.e., one may have a lighter background whereas the other may have a darker background.

For yet other embodiments, content headers may be utilized for further enhance a user's ability to comprehend content(s) of a widget. The wireless communication device may comprise a wireless transceiver and a display. The wireless transceiver may receive a textual content, a graphical content, and a content identifier, and the display may provide a visual representation of a widget. The display may provide a first window 501 including the textual content, a second window 507 including at least part of the graphical content, and a third window 509 including a content header corresponding to the content identifier. The second and third windows 507, 509 are adjacent to the first window 501, but they are positioned at opposite sides of the first window, as shown in FIG. 5. In this manner, a user's focus on the widget is upon the textual content, and the graphical content and content header support or enhance the textual content by their adjacent positions.

The first, second and third windows 501, 507, 509 are located within an outer boundary of the visual representation of the widget, and the dimensions of the windows may vary in order to further enhance a user's comprehension of the content(s) therein. For one embodiment, a first side 511 of the second window 507 adjacent to the first window 501 has a length that is different from a length of a second side 513 of the first window 501 adjacent to the second window. For another embodiment, a first side 515 of the third window 509 adjacent to the first window 501 has a length that is different from a length of a second side 517 of the first window 501 adjacent to the third window. For yet another embodiment, the length of the side 511 of the second window 507 is substantially the same as the length of the side of the third window adjacent to the first window.

Similar to other embodiments described above, the visual representations may further include distinguishing characteristics for the different types of content therein. For example, the textual content and the at least a portion of the graphical content may have differing background colors, i.e., one may have a lighter background whereas the other may have a darker background.

A widget includes one or more of the following elements. The widget may include a special icon for display in an add-widget menu. Widgets may have a special visual treatment so a user may easily identify them as separate from widgets downloaded from other devices. By attaching the icon directly to a receiver tag, a main icon may be used for an associated application, and a separate icon may be used for the widget. The widget may include standard a meta-data tag that points to a resource, such as an XML resource, describing the widget. The widget may include a standard intent filter to identify the receiver as an application widget. The widget may includes other intent filters that notify the widget when new data is available, or when data should be removed (e.g. when a service provider account is removed from the device).

While the preferred embodiments of the invention have been illustrated and described, it is to be understood that the invention is not so limited. Numerous modifications, changes, variations, substitutions and equivalents will occur to those skilled in the art without departing from the spirit and scope of the present invention as defined by the appended claims.

What is claimed is:

1. A wireless communication device comprising:
a wireless transceiver being effective to receive a textual content and a tag associated with a particular application at the wireless communication device;
a processor being effective to determine whether the wireless transceiver has received a graphical content associated with the textual content and the tag;
a display being effective to provide a visual representation of a widget associated with the tag received by the wireless transceiver, the display providing a first window including the textual content and at least a portion of the graphical content adjacent to the first window in the visual representation in response to determining that the wireless transceiver received the graphical content, the display providing a second window including the textual content in the visual representation in response to determining that the wireless transceiver has not receive the graphical content,
wherein the second window is larger than the first window.

2. The wireless communication device of claim 1, wherein the wireless transceiver receives the graphical content concurrently with the textual content and the tag.

3. The wireless communication device of claim 1, wherein the wireless transceiver receives the graphical content within a predetermined time period of receiving the textual content and the tag.

4. The wireless communication device of claim 1, wherein a width of the second window is greater than a width of the first window.

5. The wireless communication device of claim 1, wherein a height of the second window is greater than a height of the first window.

6. The wireless communication device of claim 1, wherein:
the first window has a first width and a first height;
the second window has a second width and a second height; and
the first and second widths are substantially the same whereas the second height is greater than the first height.

7. The wireless communication device of claim 1, wherein:
the first window has a first width and a first height;
the second window has a second width and a second height; and
the first and second heights are substantially the same whereas the second width is greater than the first width.

8. The wireless communication device of claim 1, wherein:
the processor is capable of executing an application associated with the widget; and
the display provides the widget at a home screen of the portable electronic device.

9. The wireless communication device of claim 1, wherein the first and second windows consists of the textual content without any graphical content, and the graphical content consists of a single graphical content without any textual content.

10. The wireless communication device of claim 1, wherein the textual content and the at least a portion of the graphical content have differing background colors.

11. A wireless communication device comprising:
a wireless transceiver being effective to receive a textual content, a graphical content, and a content identifier;
a display being effective to provide a visual representation of a widget, the display providing a first window including the textual content, a second window including at least part of the graphical content, and a third window including a content header corresponding to the content identifier,
wherein the second and third windows are adjacent to, and positioned at opposing sides of, the first window.

12. The wireless communication device of claim 11, wherein the first, second and third windows are located within an outer boundary of the visual representation of the widget.

13. The wireless communication device of claim 11, wherein a first side of the second window adjacent to the first window has a length that is different from a length of a second side of the first window adjacent to the second window.

14. The wireless communication device of claim 11, wherein a first side of the third window adjacent to the first window has a length that is different from a length of a second side of the first window adjacent to the third window.

15. The wireless communication device of claim 11, wherein a first side of the second window adjacent to the first window has a length that is substantially the same as a length of a second side of the third window adjacent to the first window.

16. The wireless communication device of claim 11, wherein at two of the first, second and third windows have differing background colors.

17. The wireless communication device of claim 11, wherein the first window has a lighter background color than the third window.
